(19) United States
(12) Patent Application Publication
(10) Pub. No.: US 2021/0060369 A1
(43) Pub. Date: Mar. 4, 2021

(54) CAPSULE TYPE FIRE EXTINGUISHER FOR PREVENTING BATTERY EXPLOSION AND BATTERY HAVING THE FIRE EXTINGUISHER

(71) Applicants: Byung Yul Kim, Cheongju-si (KR); FIREKIM Co., Ltd., Cheongju-si (KR)

(72) Inventor: Byung Yul KIM, Cheongju-si (KR)

(21) Appl. No.: 17/007,685

(22) Filed: Aug. 31, 2020

(30) Foreign Application Priority Data
Sep. 3, 2019 (KR) 10-2019-0108651

(51) Int. Cl. A62C 3/16; A62C 35/10; H01M 10/42

(52) U.S. Cl. CPC A62C 3/16; H01M 2200/10; H01M 10/4207; A62C 35/10

(57) ABSTRACT

A capsule-type fire extinguisher for preventing a battery explosion, and a battery including the capsule-type fire extinguisher are disclosed. The capsule-type fire extinguisher includes an extinguishing capsule including an extinguishing material configured to extinguish a fire by being externally discharged as being expanded and exploded by external heat in an inside thereof, a fixing member configured to fix the extinguishing capsule to the battery, and a forced exhaust provided on one side of the extinguishing capsule and configured to destroy at least one of the extinguishing capsule or the battery.

### CROSS-REFERENCE TO RELATED APPLICATION(S)

This application claims the benefit under 35 USC § 119(a) of Korean Patent Application No. 10-2019-0108651 filed on Sep. 3, 2019, in the Korean Intellectual Property Office, the entire disclosure of which is incorporated herein by reference for all purposes.

### BACKGROUND

### 1. Field

One or more example embodiments relate to a capsule-type fire extinguisher for preventing an explosion of a battery, and a battery including the fire extinguisher.

### 2. Description of Related Art

The recent development of electric vehicles, energy storage batteries, robots, satellites, or the like has spurred the research on high-performance secondary batteries capable of being charged or discharged repeatedly. In addition, there is also ongoing research on battery packs having the capacity and output power increased by connecting a plurality of secondary batteries in parallel or in series.

In a case of a high-performance and high-capacity battery pack, there is a risk of a fire and an explosion due to an overcharge and an overcurrent. To detect a potential risk of a fire and an explosion, a temperature sensor, a current sensor, a voltage sensor, and the like are used for the battery pack. In addition, to extinguish a fire when the fire is detected, a fire extinguisher is installed separately from the battery pack. However, in such a case where the fire extinguisher is installed separately from the battery pack, it may be complicated to install the fire extinguisher and not be easy to detect such a potential risk and a fire. In addition, once a fire occurs from an explosion of a battery, there may be a great deal of damage. Thus, there is a growing need for a fire extinguisher to prevent a fire and an explosion in an initial state before the fire and the explosion occurs in a battery.

Thus, there is a desire for a fire extinguisher that is installed in a battery in a simple and easy way and configured to prevent a fire or an explosion occurring when the battery expands by heat.

The above description has been possessed or acquired by the inventor(s) in the course of conceiving the present disclosure and is not necessarily an art publicly known before the present application is filed.

### SUMMARY

An aspect provides a capsule-type fire extinguisher for preventing a battery explosion, and a battery including the fire extinguisher.

According to an example embodiment, there is provided a capsule-type fire extinguisher for preventing an explosion of a battery.

The capsule-type fire extinguisher may include an extinguishing capsule including an extinguishing material configured to extinguish a fire by being externally discharged as being expanded and exploded by external heat in an inside thereof, a fixing member configured to fix the extinguishing capsule to the battery, and a forced exhaust provided on one side of the extinguishing capsule and configured to destroy at least one of the extinguishing capsule or the battery.

The forced exhaust may be formed with at least one material of a bimetallic metal, a shape-memory alloy, or a plastic material of which a shape is deformed by an electrical signal or heat.

The forced exhaust may include a support frame formed with at least one material of a bimetallic metal, a shape-memory alloy, or a plastic material of which a shape is deformed by an electrical signal or heat, and a protrusion formed by protruding from at least one side of the support frame. As a shape of the support frame is deformed by an electrical signal or heat, the support frame may press toward at least one side of the extinguishing capsule or the battery. The forced exhaust may further include an elastic support configured to elastically support the support frame. The forced exhaust may be disposed inside the extinguishing capsule or outside the extinguishing capsule. Alternatively, the forced exhaust may be disposed between the extinguishing capsule and the battery. The protrusion may be disposed on both directions such that the forced exhaust destroys both the extinguishing capsule and the battery.

The forced exhaust may be inserted into the fixing member to be disposed between the extinguishing capsule and the battery.

The fixing member may include a metal or polymer and be formed with a non-flammable and flame-retardant material.

According to another example embodiment, there is provided a battery including a capsule-type fire extinguisher. The battery may include a plurality of unit cells, and a plurality of capsule-type fire extinguishers respectively provided in the unit cells. Each of the capsule-type fire extinguishers may include an extinguishing capsule including an extinguishing material configured to extinguish a fire by being externally discharged as being expanded and exploded by external heat in an inside thereof, and a forced exhaust provided on one side of the extinguishing capsule and configured to destroy at least one of the extinguishing capsule or a corresponding unit cell.

The battery may further include a feeding pipe connected to each extinguishing capsule, and the forced exhaust may also be provided in the feeding pipe.

The forced exhaust may be formed with at least one material of a bimetallic metal, a shape-memory alloy, or a plastic material of which a shape is deformed by an electrical signal or heat. The forced exhaust may include a support frame formed with at least one material of a bimetallic metal, a shape-memory alloy, or a plastic material of which a shape is deformed by an electrical signal or heat, and a protrusion formed by protruding from at least one side of the support frame.

The forced exhaust may be disposed inside the extinguishing capsule or between the extinguishing capsule and the corresponding unit cell. Each of the capsule-type fire extinguishers may further include a fixing member configured to fix the extinguishing capsule to the corresponding unit cell. The fixing member may include a metal or polymer and be formed with a non-flammable and flame-retardant material. The forced exhaust may be inserted into the fixing member to be disposed between the extinguishing capsule and the unit cell.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a front view of an example of a battery to which a capsule-type fire extinguisher is attached according to an example embodiment;

FIGS. 2A through 2D are cross-sectional views of a capsule-type fire extinguisher according to an example embodiment;

FIG. 3 is a schematic diagram illustrating a forced exhaust of a capsule-type fire extinguisher according to an example embodiment;

FIG. 4 is a diagram illustrating an operation of a capsule-type fire extinguisher according to an example embodiment; and

FIG. 5 is a diagram illustrating another example of a battery to which a capsule-type fire extinguisher is applied according to an example embodiment.

### DETAILED DESCRIPTION

Hereinafter, example embodiments will be described in detail with reference to the accompanying drawings. It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular example embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. In addition, terms such as first, second, A, B, (a), (b), and the like may be used herein to describe components. Each of these terminologies is not used to define an essence, order, or sequence of a corresponding component but used merely to distinguish the corresponding component from other component(s). It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Hereinafter, example embodiments will be described in detail with reference to the accompanying drawings. In the description of example embodiments, detailed description of well-known related structures or functions will be omitted when it is deemed that such description will cause ambiguous interpretation of the present disclosure. Regarding the reference numerals assigned to the elements in the drawings, it should be noted that the same elements will be designated by the same reference numerals, wherever possible, even though they are shown in different drawings.

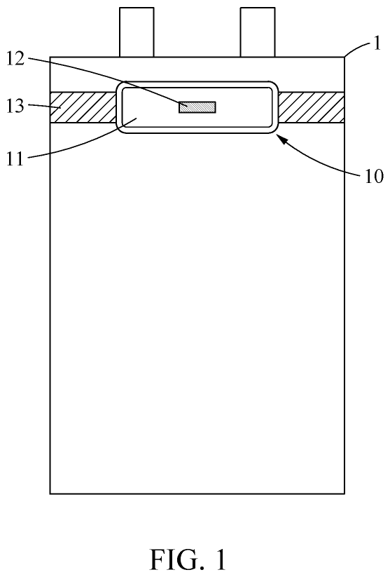

Hereinafter, a capsule-type fire extinguisher 10 according to an example embodiment will be described with reference to FIGS. 1 through 4.

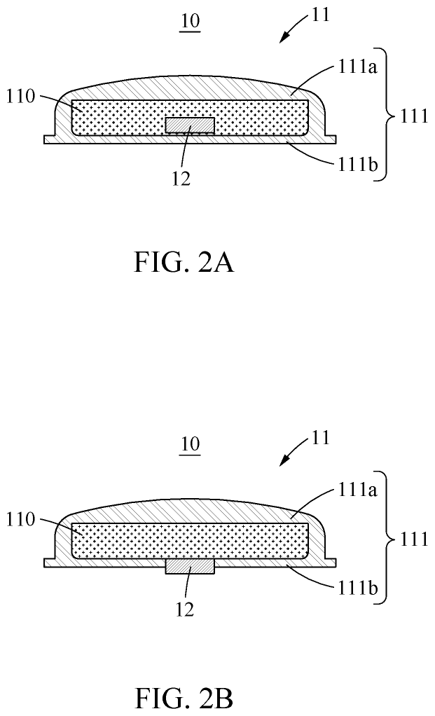

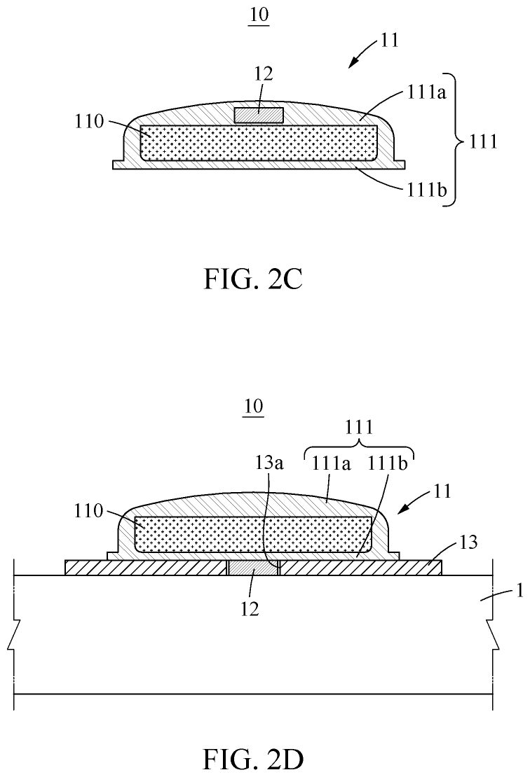

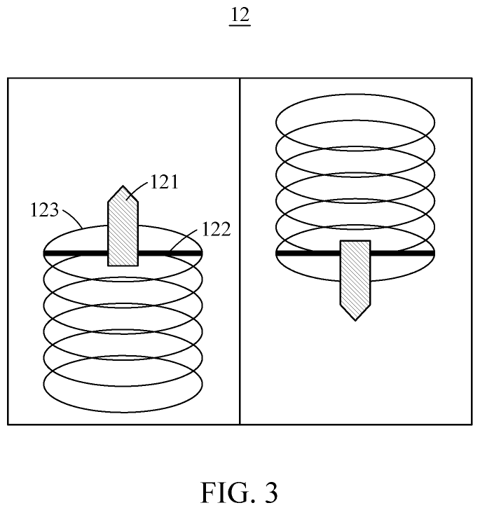

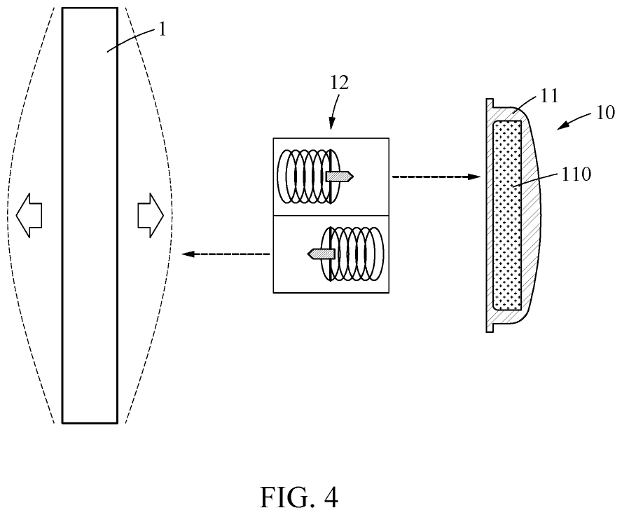

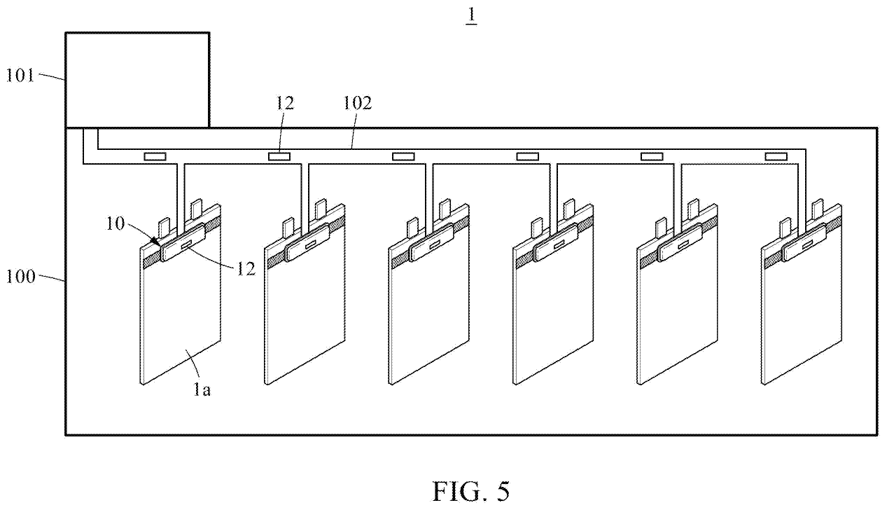

FIG. 1 is a front view of a battery 1 to which the capsule-type fire extinguisher 10 is attached according to an example embodiment. FIGS. 2A through 2D are cross-sectional views of the capsule-type fire extinguisher 10 according to an example embodiment. FIG. 3 is a schematic diagram illustrating a forced exhaust 12 of the capsule-type fire extinguisher 10 according to an example embodiment. FIG. 4 is a diagram illustrating an operation of the capsule-type fire extinguisher 10 according to an example embodiment.

Referring to the accompanying drawings, the capsule-type fire extinguisher 10 includes an extinguishing capsule 11 configured to accommodate therein an extinguishing material 110, a fixing member 13 configured to fix the extinguishing capsule 11 to the battery 1, and the forced exhaust 12 configured to destroy the extinguishing capsule 11 and the battery 1.

The extinguishing material 110 may be a material configured to extinguish a fire by being vaporized when it is heated to a predetermined temperature or higher. The extinguishing material 110 may be in a state of liquid or powder.

The extinguishing capsule 11 is configured to externally discharge the extinguishing material 110 when the extinguishing material 110 is vaporized at the temperature or higher and thus expanded and ruptured. A shape of the extinguishing capsule 11 is not limited to the illustrated shape. However, it is possible to change the shape and the size of the extinguishing capsule 11 according to an environment where it is used and installed.

The fixing member 13 is configured to attach the extinguishing capsule 11 to the battery 1. For example, the fixing member 13 may be formed with a metal or polymer material, and a non-flammable or flame-retardant material. In addition, the fixing member 13 has a shape corresponding to a surface of the extinguishing capsule 11 to which the fixing member 13 is fixed, and has a band shape, for example. However, the shape of the fixing member 13 is not limited to the illustrated shape.

The forced exhaust 12 is disposed on one side of the extinguishing capsule 11, and configured to destroy at least one of the extinguishing capsule 11 or the battery 1. For example, the forced exhaust 12 may destroy the extinguishing capsule 11 or the battery 1, or both the extinguishing capsule 11 and the battery 1. To this end, the forced exhaust 12 may be disposed inside or outside the extinguishing capsule 11, or disposed between the extinguishing capsule 11 and the battery 1.

As illustrated in FIG. 2A, the forced exhaust 12 may be disposed inside the extinguishing capsule 11. In such a case, the forced exhaust 12 may be disposed at a position close to a wall 111 of the extinguishing capsule 11 to destroy the extinguishing capsule 11 by being disposed inside the extinguishing capsule 11. Although the forced exhaust 12 is illustrated as being disposed at a position close to a rear side 111b of the extinguishing capsule 11, it may be disposed at a position close to a surface side 111a or to a side surface.

As illustrated in FIG. 2B, the forced exhaust 12 may be disposed on the rear side 111b of the extinguishing capsule 11, for example, a surface on which it is disposed on a side of the battery 1. In addition, the forced exhaust 12 may be disposed on an outer side of the wall 111 on the rear side 111b of the extinguishing capsule 11, or at least a portion of the forced exhaust 12 may be inserted into an inner side of the wall 111 or pass through the wall 111.

Alternatively, as illustrated in FIG. 2C, the forced exhaust 12 may be disposed on the surface side 111a of the extinguishing capsule 11, for example, a surface of the extinguishing capsule 11 that is opposite to the rear side 111b. Similarly, the forced exhaust 12 may be disposed on an outer side of the wall 111 on the surface side 111a of the extinguishing capsule 11, or at least a portion of the forced exhaust 12 may be inserted into an inner side of the wall 111 or pass through the wall 111.

Alternatively, as illustrated in FIG. 2D, the forced exhaust 12 may be disposed in the fixing member 13. A groove 13a may be formed at a position in the fixing member 13 between the extinguishing capsule 11 and the battery 1, and the forced exhaust 12 may be disposed in the groove 13a, thereby being capable of destroying at least one of the extinguishing capsule 11 or the battery 1.

The forced exhaust 12 includes a protrusion 121 to destroy the extinguishing capsule 11 or the battery 1, and a support frame 122 configured to press the protrusion 121 selectively toward the extinguishing capsule 11 or the battery 1.

The forced exhaust 12 may be formed with at least one material of a bimetallic metal, a shape-memory alloy, or a plastic material by which the shape of the support frame 122 is at least deformed by an electrical signal or heat. That is, as the support frame 122 is deformed by an electrical signal or heat, the protrusion 121 may be pressed toward the extinguishing capsule 11 and the battery 1, and thus the forced exhaust 12 may destroy at least one of the extinguishing capsule 11 or the battery 1.

For example, as illustrated in FIG. 4, the forced exhaust 12 may be disposed between the extinguishing capsule 11 and the battery 1, and the protrusion 121 may be disposed in both directions such that the forced exhaust 12 destroys both the extinguishing capsule 11 and the battery 1. In such a case, when the battery 1 is expanded by heat, the forced exhaust 12 may apply an impact to the battery 1 to prevent the battery 1 from being expanded, thereby preventing an explosion. In addition, by applying an impact to the extinguishing capsule 11, the forced exhaust 12 may destroy the extinguishing capsule 11 to discharge the extinguishing material 110, thereby preventing the occurrence of a fire or extinguishing the fire.

The protrusion 121 may be formed to allow the forced exhaust 12 to destroy the extinguishing capsule 11 or the battery 1.

The forced exhaust 12 further includes an elastic support 123 configured to apply an elastic force to the support frame 122.

The example of the battery 1 which is formed as a single cell has been described above. However, the capsule-type fire extinguisher 10 may also be applied to the battery 1 which includes a plurality of unit cells 1a.

Referring to FIG. 5, the battery 1 includes a plurality of unit cells 1a and a housing 100 configured to accommodate therein the unit cells 1a. The battery 1 is simply illustrated with other components omitted, except the unit cells 1a.

Each of the unit cells 1a includes the capsule-type fire extinguisher 10.

The capsule-type fire extinguishers 10 respectively provided in the unit cells 1a may be independently provided, or be connected through a feeding pipe 102 configured to supply the extinguishing material 110. In addition, the battery 1 includes a feeding tank 101 configured to supply the extinguishing material 110 to the feeding pipe 102.

The capsule-type fire extinguisher 10 may be provided in each of the unit cells 1a and the feeding pipe 102.

A position and an operation of the capsule-type fire extinguisher 10 provided in each of the unit cells 1a are the same as described above with reference to FIGS. 1 through 4. That is, the capsule-type fire extinguisher 10 may be provided on one side of each extinguishing capsule 11 and destroy at least one of each extinguishing capsule 11 and/or each unit cell 1a. Thus, a more detailed and repeated description of the capsule-type fire extinguisher 10 will be omitted here for brevity.

The forced exhaust 12 may also be provided in the feeding pipe 102. The forced exhaust 12 provided in the feeding pipe 102 may be formed in the same way as the forced exhaust 12 is formed in each unit cell 1a.

That is, the forced exhaust 12 may be formed by including the support frame 122 formed with at least one material of a bimetallic metal, a shape-memory alloy, or a plastic material of which a shape is deformed by an electrical signal or heat, and the protrusion 121 formed by protruding from the support frame 122. The forced exhaust 12 may be deformed in shape by an electrical signal or heat, thereby destroying the feeding pipe 102.

According to an example embodiment, when a unit cell 1a is heated to be a predetermined temperature or higher to be expanded, the forced exhaust 12 may apply an impact to the unit cell 1a and the extinguishing capsule 11 provided in the unit cell 1a, thereby destroying at least one of the unit cell 1a or the extinguishing capsule 11 to prevent the expansion of the unit cell 1a and prevent an explosion. In addition, the extinguishing material 110 discharged from the extinguishing capsule 11 may prevent the occurrence of a fire and extinguish the fire. Alternatively, by applying an electrical signal, it is possible to operate the forced exhaust 12 provided in the unit cell 1a.

In addition, when a unit cell 1a is heated to be a predetermined temperature or higher, a temperature of the feeding pipe 102 around the unit cell 1a may also increase to the predetermined temperature or higher, and thus the forced exhaust 12 provided in the feeding pipe 102 may operate to destroy the feeding pipe 102 and the extinguishing material 110 may be discharged.

Alternatively, when the unit cell 1a is heated to be the predetermined temperature or higher, an electrical signal may be generated to operate simultaneously the forced exhaust 12 provided in the unit cell 1a and the forced exhaust 12 provided in the feeding pipe 102.

As described above, the capsule-type fire extinguisher 10 may include the extinguishing capsule 11 including therein the extinguishing material 110 configured to expand at a predetermined temperature or higher, and may thus be small in size and simple in structure. Thus, it is possible to change the shape and the size of the capsule-type fire extinguisher 10 based on an environment where it is to be used and installed. In addition, the extinguishing capsule 11 may be destroyed by the extinguishing material 110, and also the forced exhaust 12 may also forcibly destroy the extinguishing capsule 11 and the battery 1 by an electrical signal or heat. Thus, it is possible to effectively prevent an explosion of the battery 1.

According to example embodiments described herein, a capsule-type fire extinguisher may be included in a battery, and prevent an explosion of the battery by destroying at least one of an extinguishing capsule or the battery.

The capsule-type fire extinguisher may include the extinguishing capsule of a capsule type that is configured to accommodate therein an extinguishing material, and is small in size and simple in structure. Thus, it is easy to change the shape and the size of the capsule-type fire extinguisher according to an environment where it is used and installed.

In addition, the extinguishing capsule may be automatically destroyed by the evaporation of the extinguishing material at a preset temperature or higher, and the extinguishing capsule and the battery may also be forcibly destroyed by an electrical signal or heat. Thus, it is possible to effectively prevent an explosion of the battery.

Advantageous effects of the capsule-type fire extinguisher for preventing a battery explosion and the battery including the capsule-type fire extinguisher are not limited to the foregoing, and other effects not described in the foregoing may be understood by those skilled in the art from the description provided above.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A capsule-type fire extinguisher for preventing an explosion of a battery, comprising:
an extinguishing capsule comprising an extinguishing material configured to extinguish a fire by being externally discharged as being expanded and exploded by external heat in an inside thereof;
a fixing member configured to fix the extinguishing capsule to the battery; and
a forced exhaust provided on one side of the extinguishing capsule and configured to destroy at least one of the extinguishing capsule or the battery.

2. The capsule-type fire extinguisher of claim 1, wherein the forced exhaust is formed with at least one material of a bimetallic metal, a shape-memory alloy, or a plastic material of which a shape is deformed by an electrical signal or heat.

3. The capsule-type fire extinguisher of claim 2, wherein the forced exhaust comprises:
a support frame formed with at least one material of a bimetallic metal, a shape-memory alloy, or a plastic material of which a shape is deformed by an electrical signal or heat; and
a protrusion formed by protruding from at least one side of the support frame,
wherein, as a shape of the support frame is deformed by an electrical signal or heat, the support frame is configured to press toward at least one side of the extinguishing capsule or the battery.

4. The capsule-type fire extinguisher of claim 3, wherein the forced exhaust further comprises:
an elastic support configured to elastically support the support frame.

5. The capsule-type fire extinguisher of claim 3, wherein the forced exhaust is disposed inside the extinguishing capsule or outside the extinguishing capsule.

6. The capsule-type fire extinguisher of claim 3, wherein the forced exhaust is disposed between the extinguishing capsule and the battery.

7. The capsule-type fire extinguisher of claim 6, wherein the protrusion is disposed on both directions such that the forced exhaust destroys both the extinguishing capsule and the battery.

8. The capsule-type fire extinguisher of claim 3, wherein the forced exhaust is inserted into the fixing member to be disposed between the extinguishing capsule and the battery.

9. The capsule-type fire extinguisher of claim 1, wherein the fixing member comprises a metal or polymer and is formed with a non-flammable and flame-retardant material.

10. A battery comprising a capsule-type fire extinguisher, comprising:
a plurality of unit cells; and
a plurality of capsule-type fire extinguishers respectively provided in the unit cells,
wherein each of the capsule-type fire extinguishers comprises:
an extinguishing capsule comprising an extinguishing material configured to extinguish a fire by being externally discharged as being expanded and exploded by external heat in an inside thereof; and
a forced exhaust provided on one side of the extinguishing capsule and configured to destroy at least one of the extinguishing capsule or a corresponding unit cell.

11. The battery of claim 10, further comprising:
a feeding pipe connected to each extinguishing capsule,
wherein the forced exhaust is also provided in the feeding pipe.

12. The battery of claim 10, wherein the forced exhaust is formed with at least one material of a bimetallic metal, a shape-memory alloy, or a plastic material of which a shape is deformed by an electrical signal or heat.

13. The battery of claim 12, wherein the forced exhaust comprises:
a support frame formed with at least one material of a bimetallic metal, a shape-memory alloy, or a plastic material of which a shape is deformed by an electrical signal or heat; and
a protrusion formed by protruding from at least one side of the support frame.

14. The battery of claim 12, wherein the forced exhaust is disposed inside the extinguishing capsule or between the extinguishing capsule and a corresponding unit cell.

15. The battery of claim 12, wherein each of the capsule-type fire extinguishers further comprises:
a fixing member configured to fix the extinguishing capsule to a corresponding unit cell,
wherein the fixing member comprises a metal or polymer and is formed with a non-flammable and flame-retardant material.

16. The battery of claim 15, wherein the forced exhaust is inserted into the fixing member to be disposed between the extinguishing capsule and the unit cell.
